(19) United States
(12) Patent Application Publication
(10) Pub. No.: US 2014/0220862 A1
(43) Pub. Date: Aug. 7, 2014

(54) FILM THICKNESS MONITORING METHOD, FILM THICKNESS MONITORING DEVICE, AND POLISHING APPARATUS

(71) Applicant: KABUSHIKI KAISHA TOSHIBA, Minato-ku (JP)

(72) Inventor: Toru KOIKE, Yokkaichi-shi (JP)

(73) Assignee: KABUSHIKI KAISHA TOSHIBA, Minato-ku (JP)

(21) Appl. No.: 14/019,786

(22) Filed: Sep. 6, 2013

Related U.S. Application Data
(60) Provisional application No. 61/761,991, filed on Feb. 7, 2013.

(51) Int. Cl. B24B 37/013; B24B 49/12; G01B 11/06

(52) U.S. Cl. CPC B24B 37/013; G01B 11/0633; B24B 49/12
USPC 451/5; 356/630

(57) ABSTRACT

In accordance with an embodiment, a film thickness monitoring method includes polishing an opaque film on a transparent film on a substrate, irradiating the substrate with light concurrently with the polishing of the substrate, obtaining a first signal by detecting reflected light from the substrate, acquiring first data from the first signal, and calculating a polishing amount of the opaque film using the first data. The polishing is performed by relative rotation of the substrate and a polishing table to which a polishing pad is attached. The first data is obtained by grouping the first signals obtained from positions each remote from a central position of the substrate by a same distance, and by performing data processing.

### CROSS REFERENCE TO RELATED APPLICATIONS

This application is based upon and claims the benefit of U.S. provisional Application No. 61/761,991, filed on Feb. 7, 2013, the entire contents of which are incorporated herein by reference.

### FIELD

Embodiments described herein relate generally to a film thickness monitoring method, a film thickness monitoring apparatus device, and a polishing apparatus.

### BACKGROUND

In the manufacture of a semiconductor device, various materials of films may be repeatedly formed on a wafer to form a laminated configuration. To form such a laminated configuration, it is necessary to flatten the surface of the uppermost layer. As one way for such flattening, a polishing apparatus that performs chemical mechanical polishing (which will be simply referred to as “CMP” hereinafter) is used.

In the CMP using the polishing apparatus, to execute a polishing operation without excess or deficiency, the film thickness of the uppermost layer must be accurately measured during the CMP.

### BRIEF DESCRIPTION OF THE DRAWINGS

In the accompanying drawings:

FIG. 1 is a view showing a schematic configuration of a polishing apparatus according to an embodiment;

FIG. 2 is a schematic view showing a more detailed configuration of a film thickness monitoring device included in the polishing apparatus depicted in FIG. 1;

FIG. 3 is a view showing an example of trajectories of a measurement window on a wafer depicted during relative rotation of a polishing pad and the wafer;

FIG. 4 is a graph schematically showing a relationship between a measurement point and a film thickness;

FIG. 5 is a view schematically showing a film thickness distribution before polishing obtained by film thickness measurement performed concurrently with water polishing;

FIG. 6 is a view including a graph showing an example of a waveform of reflected light with an abscissa representing a wavelength of emitted light and an ordinate representing light intensity of the reflected light;

FIG. 7 is a waveform chart showing a difference between two curves depicted in FIG. 6;

FIG. 8 is a view showing an example of plotting a polishing amount (a film thickness) of Cu by using a difference in wavelength of reflected light (a difference in intensity) with respect to incident light having a wavelength of 400 nm;

FIG. 9 is a view showing an example of plotting a polishing amount (a film thickness) of Cu by using a difference in wavelength of reflected light (a difference in intensity) with respect to incident light having a wavelength of 600 nm; and

FIG. 10 is a flowchart showing an outline procedure of a film thickness monitoring method according to an embodiment.

### DETAILED DESCRIPTION

In accordance with an embodiment, a film thickness monitoring method includes polishing an opaque film on a transparent film on a substrate, irradiating the substrate with light concurrently with the polishing of the substrate, obtaining a first signal by detecting reflected light from the substrate, acquiring first data from the first signal, and calculating a polishing amount of the opaque film using the first data. The polishing is performed by relative rotation of the substrate and a polishing table to which a polishing pad is attached. The first data is obtained by grouping the first signals obtained from positions each remote from a central position of the substrate by a same distance, and by performing data processing.

Embodiments will now be explained with reference to the accompanying drawings. Like components are provided with like reference signs throughout the drawings and repeated descriptions thereof are appropriately omitted.

(A) Polishing Apparatus

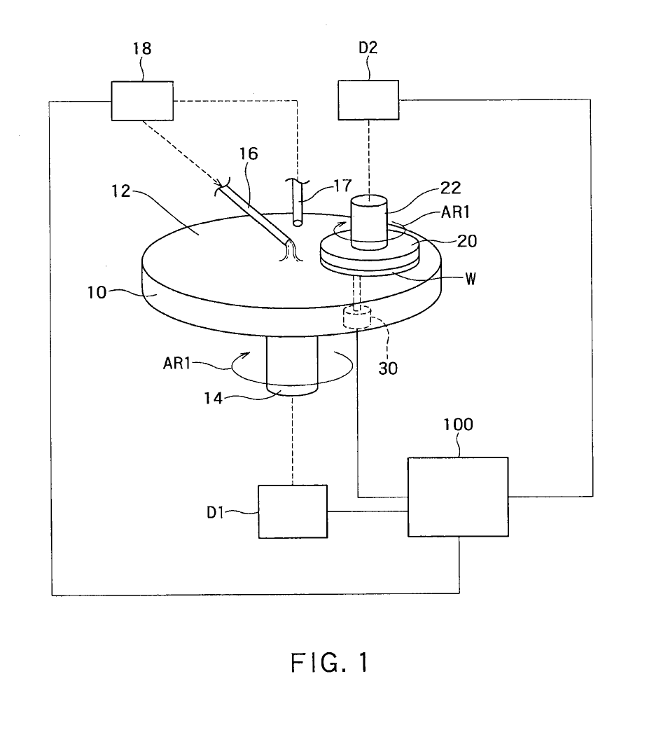

FIG. 1 is a view showing an outline configuration of a polishing apparatus according to an embodiment. The polishing apparatus shown in FIG. 1 includes a polishing table 10, a polishing table shaft 14, nozzles 16 and 17, a liquid supply control mechanism 18, a top ring 20, a top ring shaft 22, and a film thickness monitoring device 30.

The polishing table 10 is coupled with the polishing table shaft 14 and supports a polishing pad 12 on an upper surface thereof. The polishing table 10 rotates in a rotating direction indicated by reference sign AR1 in FIG. 1 when the polishing table shaft 14 rotates by a drive mechanism D1 including a motor (not shown) and others.

The top ring 20 is coupled with the top ring shaft 22, holds a wafer W in such a manner that a polishing target surface faces the polishing pad 12, and presses the wafer W against the polishing pad 12. The top ring 20 rotates in the rotating direction AR1 when the top ring shaft 22 rotates by a drive mechanism D2 including a motor (not shown) and others.

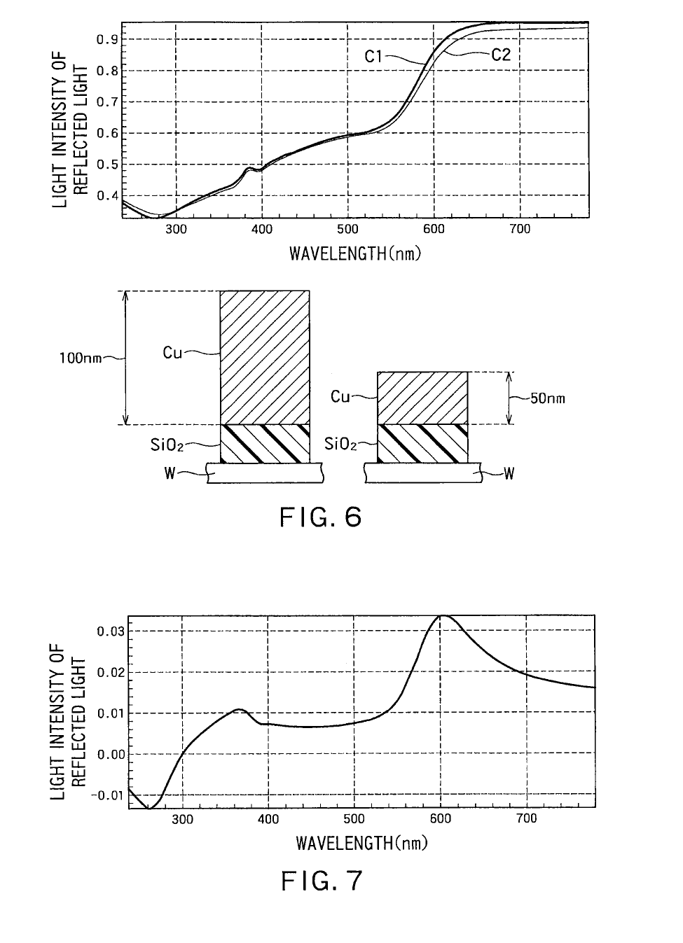

During polishing, the polishing table 20 rotates while supplying slurry onto the polishing pad 12 by the liquid supply control mechanism 18 through the nozzle 16, and the top ring 20 rotates while pressing the wafer W against the polishing pad 12, whereby a polishing target surface of the wafer W is polished by relative rotation of the polishing pad 12 and the wafer W. In this embodiment, the wafer W is, e.g., a silicon wafer having a Cu film formed on an upper surface thereof through an oxide film SiO₂, and the Cu film is a polishing target (see FIG. 6).

In this embodiment, the wafer W corresponds to, e.g., a substrate. The substrate is not restricted to a silicon wafer as a matter of course and, for example, a glass substrate or the like is also included. Further, in this embodiment, the oxide film. SiO₂ corresponds to, e.g., a transparent film, and the CU film corresponds to, e.g., an opaque film.

A control unit 100 generates each control signal, supplies it to the respective drive mechanisms D1 and D2, the liquid supply control mechanism 18, and the film thickness monitor 30, and controls the overall polishing process while monitoring a polishing amount. When a polishing amount calculated by the film thickness monitor 30 reaches a desired value, the control unit 100 terminates the polishing process.

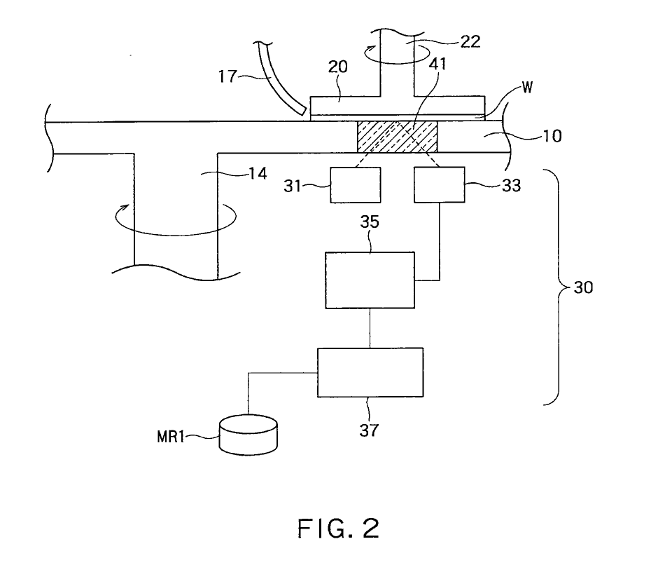

FIG. 2 is a schematic view showing a more detailed configuration of the film thickness monitoring device 30.

The film thickness monitoring device 30 includes a light emitter 31, a light receiver 33, a signal processing unit 35, and a film thickness calculation unit 37. The film thickness calculation unit 37 is connected to a memory MR1. The memory MR1 stores data concerning a variation in signal intensity relative to a polishing amount of the Cu film at a previously set wavelength.

The light emitter 31 includes, e.g., a halogen light source, emits visible light of approximately 400 nm to approximately 800 nm, and applies it to the polishing target surface of the wafer W. The light receiver 33 detects the reflected light from the polishing target surface and outputs a signal indicative of reflection intensity of the reflected light. In this embodiment, the light emitter 31 corresponds to, e.g., an irradiation unit, and the light receiver 33 corresponds to, e.g., a detection unit.

The signal processing unit 35 receives a signal from the light emitter 33 and executes later-described grouping processing.

The film thickness calculation unit 37 calculates a polishing amount of the Cu film based on a signal subjected to the grouping processing by the signal processing unit 35 and the data stored in the memory MR1.

In the polishing table 10, a measurement window 41 made of a translucent material having higher hardness than a polishing material 9, e.g., quartz glass is used for each of a portion irradiated with emitted light from the light emitter 31 and a portion through which the reflected light from the polishing target surface of the wafer W passes. Other portions of the polishing table 10 are made of, e.g., stainless so that they can cope with pressurization strength from the polishing table shaft 14.

During the polishing, since interposition of the slurry between the wafer W and each measurement window 41 is a problem, the slurry is washed out by spraying pure water from the liquid supply control mechanism 18 through the nozzle 17, and then air is injected through the nozzle 17 for removal of the pure water so that the air alone can be present between the wafer W and each measurement window 41. As a result, a film thickness of the polishing surface can be measured without removing the semiconductor substrate W from the top ring 20.

It is to be noted that the configuration for assuring optical paths of the irradiation light and the reflected light through the polishing table 10 is not restricted to the example in FIG. 2 at all. For example, an optical transmission hole may be formed in a portion corresponding to each measurement window 41 in FIG. 2 in place of the translucent member, and an optical fiber may be inserted into this hole so that the irradiation light can be allowed to pass, and a liquid such as pure water may be supplied or discharged into or from the hole, thereby avoiding scattering of the reflected light.

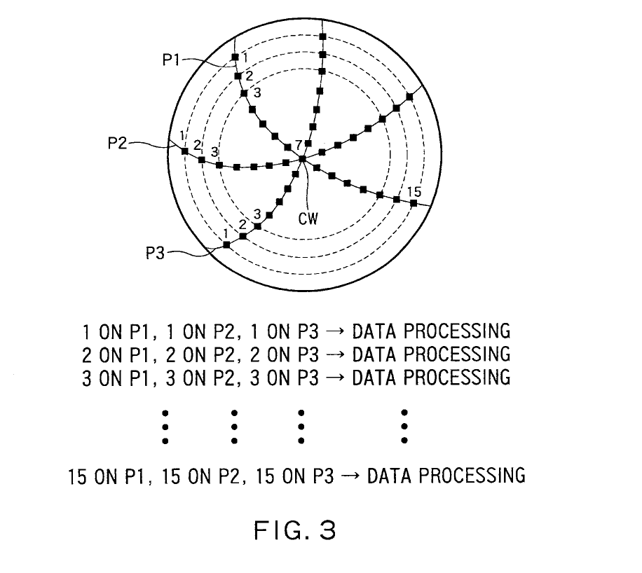

An operation of the film thickness monitoring device 30 will now be described with reference to FIG. 3 to FIG. 9.

(B) Operation of Film Thickness Monitoring Device

(1) Embodiment 1

FIG. 3 shows an example of trajectories of each measurement window 41 on the wafer W based on the relative rotation of the polishing pad 12 and the wafer W. It is to be noted that FIG. 3 shows arbitrary three rotations in all rotations of the polishing table 10 for ease of explanation.

In this embodiment, performing the grouping processing in regard to points each remote from a center CW of the wafer W by the same distance enables calculating an in-plane distribution of the wafer W. As specific processing of grouping, an average value of reflected light intensity is calculated in this embodiment.

Specifically, on trajectories P1 to P3 shown in FIG. 3, points 1 to 15 each remote from the center CW of the wafer W by the same distance are specified as measurement points 1 to 15, and average values of the measurement points 1, the measurement points 2, the measurement points 3, . . . , the measurement points 15 are calculated, respectively. It is to be noted that, in the example shown in FIG. 3, the measurement points symmetrical relative to the center CW of the wafer W are selected, but the present invention is not restricted thereto. For example, the measurement points 1 to 8 alone may be selected, and the arithmetic processing may be carried out. Further, in regard to the grouping processing, some of signals outputted from the light receiver 31, which correspond to signals from the respective measurement points, may be selected and subjected to the grouping processing, or the light receiver 31 may detect reflected lights from the respective measurement points alone and signals associated with the reflected lights may be subjected to the grouping processing. This point can be likewise applied to signals acquired by later-described water polishing.

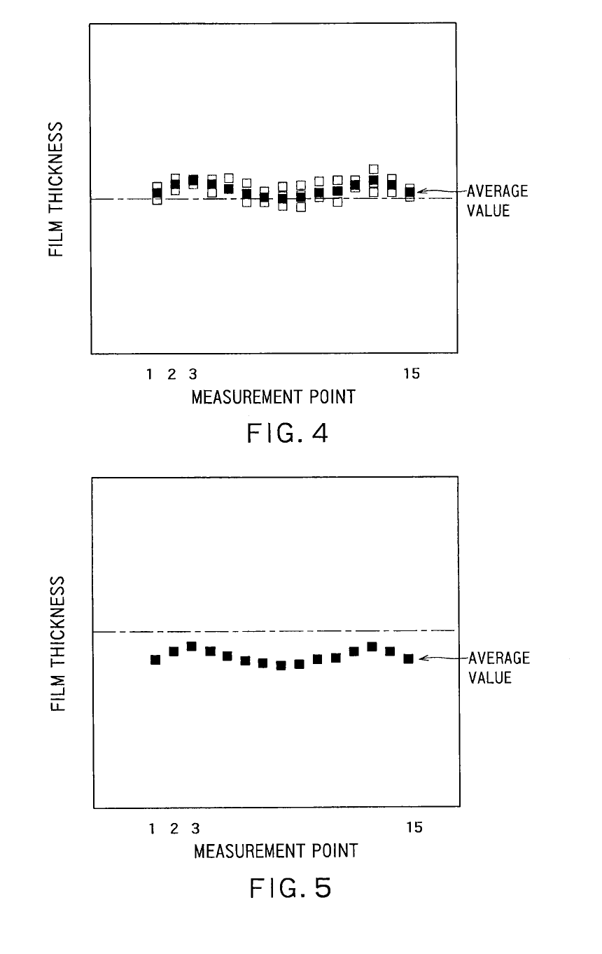

FIG. 4 is a graph schematically showing a relationship between the measurement points and film thicknesses. Although values shown in FIG. 4 cannot be calculated by current processing, this calculation is possible if information of a lower layer film and others can be accurately fetched.

An influence of the lower layer film can be eliminated if a film thickness before polishing can be acquired based on, e.g., polishing while watering the polishing pad 12 (water polishing).

FIG. 5 is a view schematically showing a film thickness distribution obtained by grouping signals acquired by three rotations of the polishing table 10 at measurement points remote from the center of the wafer W by the same distance like FIG. 3 when the water polishing is performed before the polishing and by calculating an average value in accordance with each group.

A polishing amount in the polishing process can be calculated by subtracting the film thickness shown in FIG. 5 from the film thickness depicted in FIG. 4. However, in reality, accurately fetching the information of the lower layer film in each process is difficult. Thus, in this embodiment, waveform (light intensity) information of the lower layer film is acquired by the water polishing in advance, a difference in waveform (light intensity) before start of polishing and after start of polishing is obtained, and reference is made to a prepared relational expression, thereby enabling the measurement of the polishing amount without being affected by the lower layer film. In this embodiment, the waveform (light intensity) information obtained after the start of polishing corresponds to, e.g., first data, and the waveform (light intensity) information of the lower layer film previously obtained by the water polishing corresponds to, e.g., second data.

An upper graph in FIG. 6 shows an example of waveforms of the reflected lights where an abscissa represents a wavelength of the emitted light and an ordinate represents light intensity of the reflected light. A curve C1 indicates a waveform when the Cu film thickness is 100 nm (a lower left side in FIG. 6), and a curve C2 indicates a waveform when the Cu film thickness is 50 nm (a lower right side in FIG. 6). As can be understood from the graph in FIG. 6, a difference between these curves can be observed. This difference occurs when the Cu film is polished by, e.g., 50 nm. A waveform chart in FIG. 7 shows the difference between the curves C1 and C2 depicted in FIG. 6.

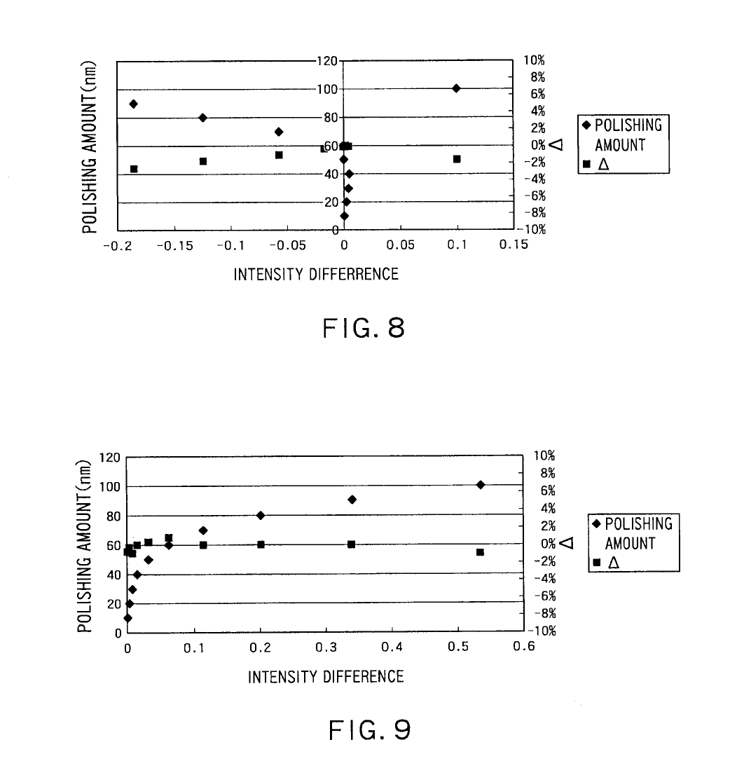

Although the waveform in FIG. 7 itself does not have great technical significance, attention is paid to a wavelength of, e.g., 400 nm here. FIG. 8 shows an example of plotting each polishing amount (a film thickness) of Cu with use of the difference in waveform of the reflected lights (a difference in intensity) in regard to incident light having the wavelength of 400 nm.

It can be understood from FIG. 8 that a difference in intensity of the reflected light is small in a region where the polishing amount is as small as 50 nm or less but the difference in intensity describes a clear curve in a region where the polishing amount is not less than 60 nm. Based on this fact, it can be understood that, if the polishing amount is not smaller than a given value, the polishing amount and the difference in intensity have a definite relationship. Therefore, if movement of this curve is calculated in advance, highly accurate measurement of the polishing amount can be realized by using a difference in wavelength in a given polishing amount range irrespective of a variation in the lower layer. It is to be noted that Δ in the drawing represents a variation of a difference in intensity when the lower layer has changed 10% in the form of % (a right axis). There is a tendency that the variation grows as the polishing amount increases, and a variation of approximately 3% may possibly occur.

In this embodiment, the relationship between the polishing amount and the difference in intensity when the polishing amount is 60 nm or more is approximated by using the following expression.

y=−173.34x+53.338 (Expression 1)

For example, when a difference in signal intensity is −0.1, the polishing amount is 75.7 nm.

(2) Embodiment 2

Embodiment 2 is common to Embodiment 1 in that waveform (light intensity) information of a lower layer film is acquired by water polishing in advance, a difference in waveform (light intensity) before start of polishing and after start of polishing is obtained, and reference is made to a prepared data table.

This embodiment is different from Embodiment 1 in that attention is paid to a wavelength of 600 nm.

FIG. 9 is a view showing that attention is paid to the wavelength of 600 nm with respect to the waveform depicted in FIG. 7 and a polishing amount (a film thickness) of Cu is plotted by using a difference in waveform (a difference in intensity) before and after a polishing process. In FIG. 9, the polishing amount describes a clear curve with respect to the difference in intensity on an abscissa, and this fact reveals that the polishing amount and the difference in intensity have a definite and clear relationship at the wavelength of 600 nm.

Therefore, when movement of such a curve of the difference in intensity and the polishing amount is calculated in advance, measurement of the polishing amount can be achieved with high accuracy by using the difference in intensity of reflected light, irrespective of a variation in film thickness of the lower layer.

It is to be noted that Δ shown in FIG. 9 represents a variation of a difference in intensity in the form of % (a right axis) when the lower layer film has changed by 10%. The variation of a difference in intensity is not greater than 1% in the entire range, and it can be understood that the difference in intensity is hardly affected by the lower layer film.

When the wavelength is selected in this manner, it is possible to cope with the polishing amount in a wider range without being substantially affected by the lower layer.

In this embodiment, the relationship between the polishing amount and the difference in intensity is approximated by using the following expression.

y=15.138Ln(x)+104.51 (Expression 2)

For example, when the difference in intensity is 0.2, the polishing amount is 80.14 nm. When attention is paid to the wavelength of 600 nm and the relationship between the difference in intensity of reflected light and the polishing amount at this wavelength is calculated in advance, the polishing amount can be measured with high accuracy.

According to the film thickness monitoring device based on at least one of the foregoing embodiments, signals of reflected lights obtained by the relative rotation of the polishing pad 12 and the wafer W are grouped at the measurement points each remote from the center of the wafer W by the same distance, an average value is calculated in each group, and hence an in-plane distribution of the wafer can be calculated.

Moreover, a relationship between the difference in intensity of the reflected light and the polishing amount at the preset wavelength is calculated in advance, the difference in intensity of the reflected light before and after polishing is obtained during polishing, and reference is made to the relationship, thereby measuring the polishing amount with high accuracy.

Additionally, according to the polishing apparatus based on at least one of the foregoing embodiments, since the film thickness monitoring device according to each of the foregoing embodiments is included, a polishing target surface alone can be polished with high accuracy by a desired polishing amount.

(C) Film Thickness Monitoring Method

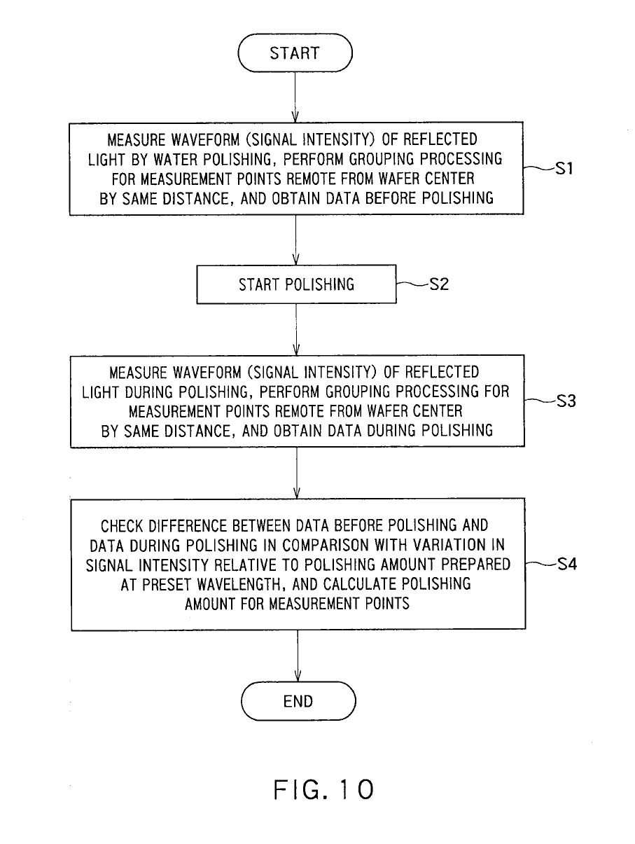

FIG. 10 is a flowchart showing an outline procedure of a film thickness monitoring method according to this embodiment.

First, water polishing is carried out before polishing, a waveform of reflected light (signal intensity) is measured, grouping processing is carried out for measurement points remote from the wafer center by the same distance, whereby data before polishing is obtained (a step S1). This data before polishing corresponds to, e.g., second data in this embodiment.

Then, the polishing is started by relative rotation of the polishing pad and the wafer (a step S2).

Further, a waveform (signal intensity) of reflected light is measured during the polishing, and the grouping processing is carried out for measurement points remote from the wafer center by the same distance, thereby obtaining data during the polishing (a step S3). This data during the polishing corresponds to, e.g., first data in this embodiment.

At last, a difference between the data before the polishing and the data during the polishing is obtained, and this difference is checked by comparison with a variation in signal intensity relative to a polishing amount prepared at a preset wavelength, whereby the polishing amount is calculated for the measurement points (a step S4).

According to the film thickness monitoring method based on at least one of the foregoing embodiments, since each signal of the reflected light obtained by the relative rotation of the polishing pad and the wafer is grouped at the measurement points each remote from the center of the wafer W by the same distance, and an average value is calculated in accordance with each group, and hence a wafer in-plane distribution can be calculated.

Furthermore, a relationship between the difference in intensity of the reflected light and the polishing amount at the preset wavelength is calculated in advance, the difference in intensity of the reflected light during the polishing is obtained, and reference is made to the above-described relationship, whereby the polishing amount can be measured with high accuracy.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A film thickness monitoring method comprising:
polishing an opaque film on a transparent film on a substrate by relative rotation of the substrate and a polishing table, a polishing pad being attached to the polishing table;
irradiating the substrate with light concurrently with the polishing of the substrate, detecting reflected light from the substrate, and obtaining a first signal from the reflected light;
grouping the first signals obtained from positions each remote from a central position of the substrate by a same distance, performing data processing, and acquiring first data; and
calculating a polishing amount of the opaque film using the first data.

2. The method of claim 1, further comprising:
performing water polishing of the substrate while watering the polishing pad prior to the polishing of the substrate;
irradiating the substrate with light concurrently with the water polishing, detecting reflected light from the substrate, and outputting a second signal;
grouping the second signals obtained from positions each remote from the central position of the substrate by a same distance, performing data processing, and acquiring second data,
wherein calculating the polishing amount comprises comparing the first data with the second data.

3. The method of claim 2, further comprising obtaining a variation amount in signal intensity relative to the polishing amount of the opaque film at a preset wavelength prior to the polishing of the substrate,
wherein the comparing comprises checking a difference between the first data and the second data by comparison with the variation amount.

4. The method of claim 1,
wherein the first signal is obtained by detecting reflected light from the positions each remote from the central position of the substrate by the same distance.

5. The method of claim 3,
wherein the preset wavelength is 400 nm, and
the variation amount is approximated by following expression:
y=−173.34x+58.388
where x is the signal intensity difference and y (≧60 nm) is the polishing amount of the opaque film.

6. The method of claim 3,
wherein the preset wavelength is 600 nm, and
the variation amount is approximated by following expression:
y=15.138Ln(x)+104.51
where x is the signal intensity difference and y is the polishing amount of the opaque film.

7. The method of claim 1,
wherein the data processing comprises obtaining an average value.

8. A film thickness monitoring device comprising:
an irradiation unit configured to irradiate a substrate comprising a transparent film and an opaque film on the transparent film, with light during polishing of the opaque film of the substrate;
a detection unit configured to detect reflected light from the substrate and output a first signal based on the reflected light;
a data processing unit configured to group the first signals obtained from positions remote from a central position of the substrate by a same distance, perform data processing, and acquire first data; and
a calculation unit configured to calculate a polishing amount of the opaque film using the first data.

9. The device of claim 8,
wherein the irradiation unit irradiates the substrate with light at the time of water polishing of the substrate performed while watering, prior to the polishing,
the detection unit detects reflected light from the substrate at the time of the water polishing and outputs a second signal,
the data processing unit groups the second signals, performs data processing, and acquires second data, and
the calculation unit compares the first data with the second data to calculate the polishing amount.

10. The device of claim 9,
wherein the comparing the first data with the second data comprises obtaining a difference between the first data and the second data, and
the calculation unit checks the difference by comparison with a variation amount in signal intensity relative to the polishing amount of the opaque film at preset wavelength which is prepared prior to the polishing of the substrate.

11. The device of claim 8,
wherein the detection unit detects reflected light from the positions each remote from the central position of the substrate by the same distance.

12. The device of claim 10,
wherein the preset wavelength is 400 nm, and
the variation amount is approximated by following expression:
y=−173.34x+58.388
where x is the signal intensity difference and y (≧60 nm) is the polishing amount of the opaque film.

13. The device of claim 10,
wherein the preset wavelength is 600 nm, and
the variation amount is approximated by following expression:
y=15.138Ln(x)+104.51
where x is the signal intensity difference and y is the polishing amount of the opaque film.

14. The device of claim 8,
wherein the data processing unit obtains an average value in regard to the grouped first signals.

15. A polishing apparatus comprising:
a polishing table configured to support a polishing pad;
a top ring configured to press a substrate against a polishing pad, the substrate comprising a transparent film and an opaque film on the transparent film; and
a film thickness monitoring device,
wherein the film thickness monitoring device comprises:
an irradiation unit configured to irradiate the substrate with light during polishing of the opaque film of the substrate;
a detection unit configured to detect reflected light from the substrate and output a first signal based on the reflected light;
a data processing unit configured to group the first signals obtained from positions remote from a central position of the substrate by a same distance, perform data processing, and acquire first data; and
a calculation unit configured to calculate a polishing amount of the opaque film using the first data.

16. The apparatus of claim 15,
wherein the irradiation unit irradiates the substrate with light at the time of water polishing of the substrate performed while watering, prior to the polishing,
the detection unit detects reflected light from the substrate at the time of the water polishing and outputs a second signal,
the data processing unit groups the second signals, performs data processing, and acquires second data, and
the calculation unit compares the first data with the second data to calculate the polishing amount.

17. The apparatus of claim 16,
wherein the comparing the first data with the second data comprises obtaining a difference between the first data and the second data, and
the calculation unit checks the difference by comparison with a variation amount in signal intensity relative to the polishing amount of the opaque film at preset wavelength which is prepared prior to the polishing of the substrate.

18. The apparatus of claim 15,
wherein the detection unit detects reflected light from the positions each remote from the central position of the substrate by the same distance.

19. The apparatus of claim 17,
wherein the preset wavelength is 400 nm, and the variation amount is approximated by following expression:
y=−173.34x+58.388
where x is the signal intensity difference and y (≧60 nm) is the polishing amount of the opaque film.

20. The apparatus of claim 17,
wherein the preset wavelength is 600 nm, and
the variation amount is approximated by following expression:
y=15.138Ln(x)+104.51
where x is the signal intensity difference and y is the polishing amount of the opaque film.
